(19) United States
(12) Patent Application Publication
(10) Pub. No.: US 2024/0019515 A1
(43) Pub. Date: Jan. 18, 2024

(54) METHOD FOR TWO-DIMENSIONAL NUCLEAR MAGNETIC RESONANCE DIFFUSION ORDERED SPECTROSCOPY BASED ON DEEP LEARNING

(71) Applicant: Xiamen University, Xiamen (CN)

(72) Inventors: Yuqing HUANG, Xiamen (CN); Zhong CHEN, Xiamen (CN); Yu YANG, Xiamen (CN); Liubin WU, Xiamen (CN); Bo CHEN, Xiamen (CN)

(21) Appl. No.: 18/143,920

(22) Filed: May 5, 2023

(30) Foreign Application Priority Data
Jul. 13, 2022 (CN) 202210820413.9

(51) Int. Cl. G01R 33/46; G01N 24/08

(52) U.S. Cl. CPC G01R 33/4625; G01N 24/087; G01R 33/4633

(57) ABSTRACT

A method for processing two-dimensional (2D) nuclear magnetic resonance (NMR) Diffusion Ordered Spectroscopy (DOSY) based on deep learning comprises constructing a simulated dataset by generating simulated data using a mathematical model based on signal characteristics of the 2D NMR DOSY, generating labels for training a deep learning network model, wherein the labels comprise a first two-dimensional matrix, and two dimensions of the first two-dimensional matrix comprise chemical shift and diffusion coefficients, constructing the deep learning network model and setting training parameters of the deep learning network model, training the deep learning network model using the simulated dataset, and testing the deep learning network model.

### RELATED APPLICATIONS

This application claims priority to Chinese patent application 202210820413.9, filed on Jul. 13, 2022. Chinese patent application 202210820413.9 is incorporated herein by reference.

### FIELD OF THE DISCLOSURE

The present disclosure relates to the technical field of Nuclear Magnetic Resonance (NMR), and in particular relates to a method for processing two-dimensional (2D) Nuclear Magnetic Resonance (NMR) Diffusion Ordered Spectroscopy (DOSY) based on deep learning.

### BACKGROUND OF THE DISCLOSURE

Nuclear Magnetic Resonance (NMR) is a versatile analytical technique allowing for composition analysis and molecular structure elucidation from mixture samples, thus widely used in the fields of chemistry, pharmacology, and biology. Diffusion Ordered Spectroscopy (DOSY) is an effective NMR technique used for analyzing components of the mixture samples. By processing DOSY experimental data, a two-dimensional spectrum can be constructed, wherein one dimension of the two-dimensional spectrum represents chemical shift, and the other dimension of the two-dimensional spectrum represents diffusion coefficients. This technique can be used for separation and identification of the components in the mixture samples, as well as for an analysis of interactions between the components.

In high-resolution DOSY, observed peaks of the same molecule exhibit excellent alignment, and peaks of different compounds can be well separated. Various processing methods have been proposed to reconstruct the high-resolution DOSY from experimental data, and the various processing methods can be roughly classified into two categories: univariate methods and multivariate methods. The univariate methods such as multi-exponential fitting, constrained regularization (CONTIN), entropy maximization (MaxEnt), and information rapidly-exploring random tree (iRRT) independently fit a decay of an individual one-dimensional signal and generally perform well in processing data with high signal-to-noise ratios. However, in practical applications, experimental noise often leads to poor alignment of peaks belonging to the same chemical component. Different from the univariate methods, the multivariate methods simultaneously process multiple one-dimensional signals or an entire spectrum. Advantages of the multivariate methods lie in an ability to utilize information from non-overlapping signals to improve resolution and accuracy of overlapping signals.

From another perspective, methods for processing DOSY can also be divided into exponential fittings and inverse laplace transforms (ILT). Some of the multivariate methods such as component resolved NMR (CORE), speedy component resolution (SCORE), and direct exponential curve resolution algorithm (DECRA), belong to the exponential fittings. These methods can directly output predicted diffusion coefficients but require exact quantity of components in the mixture samples as the prior knowledge. Different from the exponential fittings, the ILT generates a diffusion coefficient distribution spectrum rather than directly providing an exact value of the diffusion coefficients. Peak positions represent most likely values of the diffusion coefficients, and full widths of half height of these peaks indicate an uncertainty. A construction of the diffusion coefficient distribution spectrum is regarded as an inverse problem, and many algorithms have been proposed to solve the inverse problem, including Non-Negative Least Mean Squares (NNLMS), CONTIN, MaxEnt, Iterative Thresholding Algorithm for Multi-Exponential Decay (ITAMED), Enhanced Discerning Multidimensional Inverse Laplace Transform (EDMILT), Low-rank and sparse inverse Laplace transform (LRSpILT), etc. The main differences between these algorithms lie in applied regularization methods. Although ILT methods do not require actual numbers of molecular components as inputs, the ILT methods require some adjustments for optimizing regularization parameters. Only when these adjustments of the regularization parameters are made properly, can expected results be obtained.

With a development of deep learning, more neural network frameworks have been developed and widely used in a variety of fields, such as data processing of machine translation, computer vision, medical imaging, NMR, etc. In the method for processing the DOSY, Coordinated Multi-exponential Fitting (CoMeF) is a method for processing the DOSY using lightweight neural networks to solve highly nonlinear and non-convex optimization problems. However, the CoMeF is not a true deep learning method in that the CoMeF only uses a neural network as an optimizer, and a training process of the CoMeF resembles an iterative solution to a non-convex optimization problem. In other words, when dealing with multiple DOSY experimental data, each data needs to be trained independently, which is time-consuming. There are still two challenges in using deep learning methods for processing the DOSY: (1) the deep learning methods usually require a large number of training samples, but it is impossible to construct a data set large enough for the DOSY due to limitations of experimental samples and instrument time, and (2) in most neural networks, a dimensional size of testing data should be the same as a dimensional size of the training data. However, a size of a signal obtained from Pulse Gradient Spin-Echo (PGSE) experiments varies following changes in the experimental samples and instrument parameters, especially in a gradient dimension.

### BRIEF SUMMARY OF THE DISCLOSURE

The primary objective of the present disclosure is to provide a method for processing two-dimensional (2D) nuclear magnetic resonance (NMR) Diffusion-Ordered Spectroscopy (DOSY) based on deep learning to solve the aforementioned deficiencies in existing techniques. The method can address needs for prior knowledge and issues for complicated parameter adjustment associated with the traditional DOSY processing. Furthermore, the method can quickly process DOSY in various sizes with excellent alignment, high resolution, and strong robustness of spectral peaks.

The present disclosure comprises the following steps.

A method for processing two-dimensional (2D) nuclear magnetic resonance (NMR) Diffusion Ordered Spectroscopy (DOSY) based on deep learning, comprising:
step 1: constructing a simulated dataset by generating simulated data using a mathematical model based on signal characteristics of the 2D NMR DOSY, the mathematical model is as follows:

$$S ( f , b ) = {\sum }_{l = 1}^{N} {e}^{- {D}_{l} b} {C}_{l} ( f ) + ε$$

$$wherein$$

$$b = - {γ}^{2} {δ}^{2} {g}^{2} {Δ}^{′} , \\ {C}_{l} ( f ) = {\sum }_{i = 1}^{M} \frac{{w}_{i}}{{( f - {f}_{i} )}^{2} + {w}_{i}^{2}} {A}_{i} ,$$

f is a frequency of atom nuclear resonance, Dₗ is a diffusion coefficient of an I-th molecular component, γ is a magnetogyric ratio, δ is a gradient pulse width, g is a pulsed field gradient amplitude, Δ′ is a diffusion time corrected by a finite gradient pulse width, Cₗ(f) is a spectrum of the I-th molecular component and is simulated as a linear combination of peaks with Lorentzian line shapes along a frequency dimension, fᵢ is a position of an i-th peak, wᵢ is a full width at half height of the i-th peak, Aᵢ is an amplitude of the i-th peak, and ε is Gaussian noise;
step 2: generating labels for training a deep learning network model, wherein the labels comprise a first two-dimensional matrix, and two dimensions of the first two-dimensional matrix comprise chemical shift and diffusion coefficients;
step 3: constructing the deep learning network model and setting training parameters of the deep learning network model, wherein the deep learning network model comprises a body structure, a loss function, and the training parameters;
step 4: training the deep learning network model using the simulated dataset, wherein the training the deep learning network model using the simulated dataset comprises normalizing the simulated dataset to yield a normalized simulated dataset, then feeding the normalized simulated dataset into the deep learning network model, then calculating output of the deep learning network model and the labels using a mean square loss function to obtain a loss value, obtaining a gradient of the training parameters by a backpropagation algorithm, updating parameters of the deep learning network model to obtain a new deep learning network model by an Adaptive Moment Estimation (Adam) optimization algorithm based on the gradient of the training parameters, then inputting the simulated dataset into the new deep learning network model to obtain a new loss value, iteratively updating parameters of the new deep learning network model until decline of the new loss value decreases or a set number of training rounds is reached, and terminating the training to obtain a trained deep learning network model; and
step 5: testing the deep learning network model, wherein the testing the deep learning network model comprises firstly interpolating and fitting the 2D NMR DOSY in a gradient dimension, then normalizing to yield normalized 2D NMR DOSY, feeding the normalized 2D NMR DOSY into the trained deep learning network model to output a second two-dimensional matrix, two dimensions of the second two-dimensional matrix are respectively chemical shift and diffusion coefficients.

In a preferred embodiment, the body structure of the deep learning network model in the step 3 comprises a first linear layer followed by N body modules, each of the N body modules comprises a multi-head attention module, a feed-forward module, and two Add&Norm modules, wherein the multi-head attention module is a core architecture of the deep learning network model, the feed-forward module comprises two second linear layers, and the two second linear layers comprise a dropout layer and a nonlinear activation unit, and each of the two Add&Norm module comprises a residual connection and a LayerNorm layer, wherein the multi-head attention module is constructed by: firstly obtaining three matrices Q, K, and V by passing through three different third linear layers using an input matrix, uniformly dividing into multiple blocks, feeding the multiple blocks into an attention module for calculation, wherein a mathematical model of the attention module is as follows:

$${A}_{h} = softmax ( \frac{{QK}^{T}}{\sqrt{{d}_{k}}} ) V$$

wherein Q is a query matrix, K is a key matrix, V is a value matrix, dₖ is a last dimensional value of the key matrix, and Aₕ is an attention matrix calculated by an h-th head of the attention module, and splicing an output of the attention module to form a complete multi-head attention module by passing through a fourth linear layer.

As described above, compared with the existing techniques, the present disclosure has the following advantages.
(1) The present disclosure provides a method for processing 2D NMR DOSY based on deep learning. Initially, simulated data is generated by a relevant mathematical model to construct a simulated dataset based on signal characteristics of 2D NMR DOSY. Labels are generated to train a deep learning network model, and the labels comprise a two-dimensional matrix comprising chemical shift and diffusion coefficients. The deep learning network model is constructed, training parameters are set, and the simulated dataset is used for training the deep learning network model. The trained deep learning network model is tested using the 2D NMR DOSY. The method eliminates a need for an exact quantity of molecular components of a test sample as prior knowledge, and a training strategy of the deep learning network model based on the simulated data obviates requirements of large amounts of experimental data collection.
(2) The method provided by the present disclosure is computationally efficient, generally taking only a few seconds for inference on each data, and has high processing speed.

### BRIEF DESCRIPTION OF THE DRAWINGS

FIG. 1 illustrates a schematic diagram of a training procedure of a deep learning network model according to an embodiment of the present disclosure.

FIG. 2 illustrates a structure of the deep learning network model according to the embodiment of the present disclosure.

FIGS. 3A and 3B illustrate two-dimensional (2D) spectra obtained by processing test data with the trained deep learning network model according to the embodiment of the present disclosure.

The present disclosure is further described below in combination with the accompanying drawings and embodiments.

### DETAILED DESCRIPTION OF THE EMBODIMENTS

The present disclosure provides a method for processing two-dimensional (2D) Nuclear Magnetic Resonance (NMR) Diffusion Ordered Spectroscopy (DOSY) based on deep learning to solve needs for prior knowledge and complicated parameter adjustment in traditional DOSY processing methods. Moreover, the DOSY in various dimensions can be quickly processed using the method with excellent alignment, high resolution, and strong robustness of spectral peaks.

In order to enable a person of skill in the art to well implement and understand the present disclosure, the present disclosure is further described below in combination with the accompanying drawings and embodiments. It should be understood that the embodiments described here are only used to explain and describe the present disclosure instead of being used to limit the present disclosure.

In order to facilitate the description, related professional terms in the embodiments are described as follows:
Inverse Laplace Transform: ILT,
2D NMR Diffusion Ordered Spectroscopy: 2D NMR DOSY, and
Adaptive Moment Estimation: Adam

In this embodiment, a trained deep learning network model for simulated data is generated, the trained deep learning network model is used to process data, and a corresponding relationship spectrum between chemical shift and diffusion coefficients is obtained to analyze interaction between molecules and to identify compositions of a mixture. When the deep learning network model is trained, dimensional sizes of input S₁ are: 48×300×30, wherein 48 is a batch size, 300 is a dimensional size of the chemical shift, and 30 is dimensional sizes of input decay signals. Dimensional sizes of output data S₂ are: 48×300×140, wherein 48 is a batch size, 300 is a dimensional size of the chemical shift, and 140 is a dimensional size of the diffusion coefficients. The deep learning network model has good versatility. When the DOSY data is processed, there are no restrictions on the dimensional size of the chemical shift or the dimensional sizes of the input decay signals. The output dimensional size of the chemical shift is the same as the input dimensional size of the chemical shift, and the output dimensional size of the diffusion coefficients is fixed at 140.

The specific steps are as follows:
Step 1: A simulated dataset is constructed by generating simulated data using a relevant mathematical model and adding simulated noise based on signal characteristics of the 2D NMR DOSY.

The relevant mathematical model is as follows.

$$S ( f , b ) = {\sum }_{l = 1}^{N} {e}^{- {D}_{l} b} {C}_{l} ( f ) + ε$$

$$Wherein$$

$$b = - {γ}^{2} {δ}^{2} {g}^{2} {Δ}^{′} , \\ {C}_{l} ( f ) = {\sum }_{i = 1}^{M} \frac{{w}_{i}}{{( f - {f}_{i} )}^{2} + {w}_{i}^{2}} {A}_{i} ,$$

f is a frequency of atom nuclear resonance, D₁ is a diffusion coefficient of an I-th molecular component, γ is a magnetogyric ratio, δ is a gradient pulse width, g is a pulsed field gradient amplitude, and Δ′ is diffusion time corrected by a finite gradient pulse width. Cₗ(f) is a spectrum of the I-th molecular component and is simulated as a linear combination of peaks with Lorentzian line shapes along a frequency dimension, wherein fᵢ is a position of an i-th peak, wᵢ is a full width at half height of the i-th peak, Aᵢ is an amplitude of the i-th peak, and ε is Gaussian noise. In this embodiment, b is a one-dimensional array uniformly distributed in an interval from 0 to 1.2, and a length of the array is 30. Dₗ is a random number between 0 and 14, l is a random integer between 1 and 3, fᵢ is a random integer between 0 and 300, wᵢ is 18, and Aᵢ is a random number between 0 and 1.
Step 2: Labels for training the deep learning network model are generated. The labels are a two-dimensional matrix with two dimensions representing the chemical shift and the diffusion coefficients. In this embodiment, the dimensional size of the chemical shift is 300, and the dimensional size of the diffusion coefficients is 140. The dimensional size of the chemical shift in this embodiment is the same as a dimensional size of a chemical shift of the simulated dataset. The ILT method is used to generate a dimensional size of the diffusion coefficients, and the Gaussian distribution is used to represent a possibility value of various diffusion coefficients. A central value of the Gaussian distribution (e.g., a position of a spectral peak) is a predict value of the diffusion coefficients, and a full width at a half height of the spectral peak corresponds to a confidence interval.
Step 3: The deep learning network model is constructed, and training parameters are set.

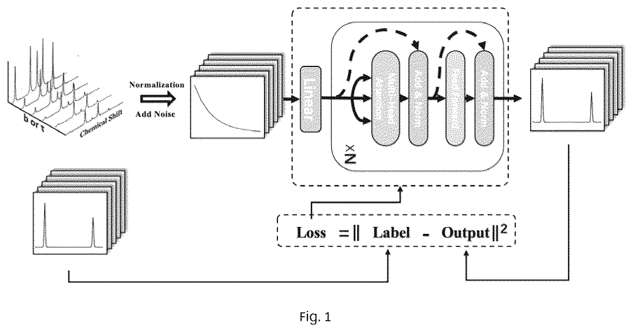

The deep learning network model is shown in FIG. 1. The deep learning network model comprises a body structure, a loss function, and the training parameters. The body structure of the deep learning network model consists of a first linear layer followed by N body modules. Each of the N body modules comprises a multi-head attention module, a feed forward module, and two Add&Norm modules. The multi-head attention module is a core architecture of the deep learning network model. An input matrix firstly passes through three matrices to obtain three different second linear layers: Q (Query), K (Key), and V (Value). The three matrices are then divided into multiple blocks (also referred to as “multi-head” to improve a training flexibility of the deep learning network model) and fed to an attention module for calculation. A mathematical model of the attention module is as follows:

$${A}_{h} = softmax ( \frac{{QK}^{T}}{\sqrt{{d}_{k}}} ) V .$$

Output from the attention module is spliced to form the complete multi-head attention module by a third linear layer. The feed forward module consists of two fourth linear layers, a dropout layer, and a non-linear activation unit ReLU. Each of the two Add&Norm modules comprises residual connections and a layer norm layer. Aₕ is an attention matrix calculated by an h-th head of the attention module, Q is a query matrix, K is a key matrix, V is a value matrix, and dₖ is a last dimensional value of the key matrix.

In this example, the linear layers preceding the body structure of the deep learning network model expand dimensional sizes of the input decay signals from 30 to 140 by setting the training parameters from 30 to 140. 6 body modules of the N body modules are provided, and 7 heads of the multi-head attention module are provided. In the feed forward module, parameters of the two fourth linear layers are respectively set to 140-4096 and 4096-140, and dropout is set to 0.001.
Step 4: The deep learning network model is trained using the generated simulated dataset.

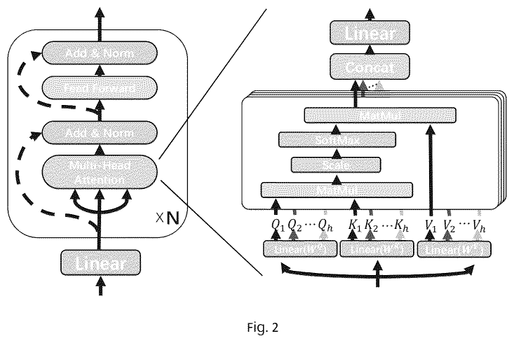

As shown in FIG. 2, the simulated dataset constructed in the step 1 is firstly normalized to obtain normalized data by dividing each of the input decay signals by a first value of the input decay signals, ensuring that the input decay signals decay from 1. The normalized data is then fed into the deep learning network model, and loss values of the output and the labels of the deep learning network model are obtained by calculating the mean square error (MSE) function. A parameter gradient is obtained by a backpropagation algorithm, and the parameters of the deep learning network model are updated to obtain a new deep learning network model by the Adam optimization algorithm based on the parameter gradient. The new deep learning network model is then fed with the simulated dataset to obtain a new loss value, iterative updating of parameters of the deep learning network model continues until decline of the loss value decreases or a set number of training rounds is reached, and the training is terminated. The loss value represents errors between the output and the labels. When the errors are smaller, the output more approaches the labels, and output performance of the deep learning network model is better. In this embodiment, an initial learning rate is set to 10-3, the batch size is set to 48, and the training rounds of the deep learning network model are set to 40.
Step 5: The deep learning network model is tested.

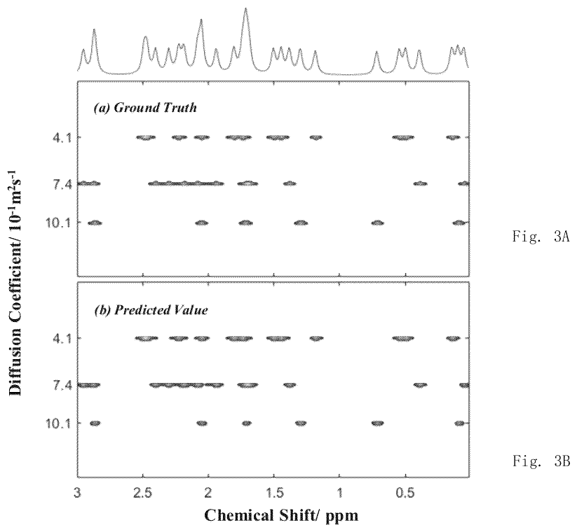

The DOSY is firstly interpolated and fitted using a gradient dimension algorithm, followed by normalization (e.g., each of the input decay signals is divided by a first value of the input decay signals, ensuring that the input decay signals decay from 1). Data after the normalization then feeds into the trained deep learning network model to output a two-dimensional matrix, as shown in a contour map illustrated in FIGS. 3A and 3B. FIG. 3A illustrates ground truth generated in Step 2, and FIG. 3B illustrates predicted results of the deep learning network model. A one-dimensional curve above FIGS. 3A and 3B illustrates a corresponding nuclear magnetic resonance hydrogen (HNMR) spectrum. Vertical coordinates of a peak center value in the contour map is the value of the diffusion coefficients of a certain molecular component, and a horizontal coordinate of the peak center value in the contour map corresponds to the chemical shift in the one-dimensional HNMR. A linear width in a diffusion dimension represents an uncertainty of the value estimated by the deep learning network model. Results of this embodiment are shown in FIGS. 3A and 3B. Three different diffusion coefficients in the diffusion dimension correspond to three different molecular components, and the results exhibit good alignment and low uncertainty. Overall, the method for processing two-dimensional (2D) Nuclear Magnetic Resonance (NMR) Diffusion Ordered Spectroscopy (DOSY) based on deep learning has high accuracy, high robustness, and high processing speed.

The specific embodiments described in the specification are merely used to explain in an exemplary manner the spirit of the present disclosure. Thus, it is intended that the present disclosure cover any modifications and variations of the presently presented embodiments provided that a person skilled in the art can modify or supplement the specific embodiments described herein or replace the specific embodiments described herein using similar methods.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure.

What is claimed is:

1. A method for processing two-dimensional (2D) nuclear magnetic resonance (NMR) Diffusion Ordered Spectroscopy (DOSY) based on deep learning, comprising:
step 1: constructing a simulated dataset by generating simulated data using a mathematical model based on signal characteristics of the 2D NMR DOSY,
the mathematical model is as follows:
$$S ( f , b ) = {\sum }_{l = 1}^{N} {e}^{- {D}_{l} b} {C}_{l} ( f ) + ε$$
$$wherein$$
$$b = - {γ}^{2} {δ}^{2} {g}^{2} {Δ}^{′} , \\ {C}_{l} ( f ) = {\sum }_{i = 1}^{M} \frac{{w}_{i}}{{( f - {f}_{i} )}^{2} + {w}_{i}^{2}} {A}_{i} ,$$
f is a frequency of atom nuclear resonance, Dₗ is a diffusion coefficient of an I-th molecular component, γ is a magnetogyric ratio, δ is a gradient pulse width, g is a pulsed field gradient amplitude, Δ′ is a diffusion time corrected by a finite gradient pulse width, Cₗ(f) is a spectrum of the I-th molecular component and is simulated as a linear combination of peaks with Lorentzian line shapes along a frequency dimension, fᵢ is a position of an i-th peak, wᵢ is a full width at half height of the i-th peak, Aᵢ is an amplitude of the i-th peak, and ε is Gaussian noise;
step 2: generating labels for training a deep learning network model, wherein the labels comprise a first two-dimensional matrix, and two dimensions of the first two-dimensional matrix comprise chemical shift and diffusion coefficients;
step 3: constructing the deep learning network model and setting training parameters of the deep learning network model, wherein the deep learning network model comprises a body structure, a loss function, and the training parameters;
step 4: training the deep learning network model using the simulated dataset, wherein the training the deep learning network model using the simulated dataset comprises normalizing the simulated dataset to yield a normalized simulated dataset, then feeding the normalized simulated dataset into the deep learning network model, then calculating output of the deep learning network model and the labels using a mean square loss function to obtain a loss value, obtaining a gradient of the training parameters by a backpropagation algorithm, updating parameters of the deep learning network model to obtain a new deep learning network model by an Adaptive Moment Estimation (Adam) optimization algorithm based on the gradient of the training parameters, then inputting the simulated dataset into the new deep learning network model to obtain a new loss value, iteratively updating parameters of the new deep learning network model until decline of the new loss value decreases or a set number of training rounds is reached, and terminating the training to obtain a trained deep learning network model; and
step 5: testing the deep learning network model, wherein the testing the deep learning network model comprises firstly interpolating and fitting the 2D NMR DOSY in a gradient dimension, then normalizing to yield normalized 2D NMR DOSY, feeding the normalized 2D NMR DOSY into the trained deep learning network model to output a second two-dimensional matrix, two dimensions of the second two-dimensional matrix are respectively chemical shift and diffusion coefficients.

2. The method for processing 2D NMR DOSY based on deep learning according to claim 1, wherein:
the body structure of the deep learning network model in the step 3 comprises a first linear layer followed by N body modules, each of the N body modules comprises a multi-head attention module, a feed-forward module, and two Add&Norm modules, wherein the multi-head attention module is a core architecture of the deep learning network model,
the feed-forward module comprises two second linear layers, and the two second linear layers comprise a dropout layer and a nonlinear activation unit, and
each of the two Add&Norm modules comprises a residual connection and a LayerNorm layer, wherein the multi-head attention module is constructed by:
firstly obtaining three matrices Q, K, and V by passing through three different third linear layers using an input matrix,
uniformly dividing into multiple blocks,
feeding the multiple blocks into an attention module for calculation, wherein a mathematical model of the attention module is as follows:
$${A}_{h} = softmax ( \frac{{QK}^{T}}{\sqrt{{d}_{k}}} ) V$$
wherein Q is a query matrix, K is a key matrix, V is a value matrix, dₖ is a last dimensional value of the key matrix, and Aₕ is an attention matrix calculated by an h-th head of the attention module, and
splicing an output of the attention module to form a complete multi-head attention module by passing through a fourth linear layer.
